(19) United States
(12) Patent Application Publication
(10) Pub. No.: US 2006/0070944 A1
(43) Pub. Date: Apr. 6, 2006

(54) Food cooking apparatus with rotatable strainer

(76) Inventors: Juhn Ho Ahn, Niles, IL (US); Young K. Ahn, Niles, IL (US)

Correspondence Address: Douglas H. Pauley;Pauley Petersen & Erickson, Suite 365, 2800 West Higgins Road, Hoffman Estates, IL, 60195, US

(21) Appl. No.: 11/024,588

(22) Filed: Dec. 29, 2004

Related U.S. Application Data
(60) Provisional application No. 60/616,032, filed on Oct. 5, 2004.

(51) Int. Cl. B01D 35/00

(52) U.S. Cl. 210/470; 210/473; 210/499; 210/471; 99/508

(57) ABSTRACT

A food cooking apparatus having a container that forms a housing. A strainer is positioned within the housing and is rotatably mounted with respect to the container. A pressing element, such as a tab, is connected with respect to the container. When the container is filled with a cooking liquid, such as hot water, the strainer can be held with a handle and the tab can be pressed to apply a torquing force that rotates the container into a dumping position while simultaneously maintaining a generally horizontal position of the strainer, for example to prevent food from falling out of the strainer.

### BACKGROUND OF THE INVENTION

1. Field of the Invention

This invention relates to kitchen utensils for cooking procedures, including rinsing cooked pastas, fruits, vegetables and other foods or similar products. More particularly, this invention relates to a colander or container that fits within a bowl or pot, wherein the bowl or pot can be rotated or turned with respect to the colander, for example with either a right hand or a left hand of a user.

2. Discussion of Related Art

When rinsing foods with conventional colander or strainer devices, multiple bowls are typically required, particularly when rinsing or draining liquids from cooked pastas. Conventional kitchen utensils need to be poured in an upside down fashion, which requires extreme care. Quite often the food and/or the colander or strainer falls out of the kitchen utensil, such as out of a bowl or a pot, and onto a working surface or a ground surface.

Pastas, vegetables or other similar foods are often cooked in a pot containing hot water. When the food is finished cooking, the hot water and the food are often dumped into a strainer, which often requires both hands of a user. Not only is there a danger that the user can be easily burned, but also the food can stick to an inside surface of the pot or other cooking vessel.

In other known food cooking processes, a strainer is positioned within a pot of hot water and then the food is placed into the hot water so that the strainer is between the pot and the food. When the food is finished cooking, the user can lift the strainer and all of the food within the strainer out of the hot water. However, when the user moves the strainer to a sink or other drain facility, the food and/or the strainer can drip hot water onto a work surface or a ground surface, which can also create a hazardous environment and/or an unclean work area.

There is a need for a food cooking apparatus that can be easily operated with a single hand, either a right hand or a left hand, so that the hot cooking water can be separated from cooked foodstuffs without creating a mess and/or a hazardous condition.

### SUMMARY OF THE INVENTION

It is one object of this invention to provide a food cooking apparatus that can be operated with one hand of a user.

It is another object of this invention to provide a food cooking apparatus that prevents pasta, rice, vegetables and other similar foodstuffs from sticking on an inside wall of the cooking pot.

The above and other objects of this invention are accomplished with a food cooking apparatus having a container, such as a bowl, a vessel or another suitable cooking pot, and a strainer that fits within a housing formed by the container. The strainer is preferably rotatably mounted with respect to the container. In one embodiment of this invention, a shaft is connected to the strainer and is preferably fixed in position with respect to the strainer. When the shaft is fixed with respect to the strainer, the shaft can be rotated with respect to the container, which causes the strainer to rotate with respect to the container.

A handle can be fixed with respect to the strainer and/or the shaft. Thus, a user can grasp the handle and thereby control a position of the strainer and/or the shaft relative to a position of the strainer.

A pressing element is preferably connected with respect to the container. For example, a tab, a handle or another suitable structural element can be used as the pressing element. When a user grasps the handle and establishes a controlled position of the strainer with the handle, the user can then apply a finger, even from the same hand, to press upon the pressing element or tab and thereby rotate the container with respect to the strainer. Thus, the user can contain food within the strainer, and maintain the strainer in a generally level position so that food does not fall out of the strainer, while rotating the container to dump the hot water or other hot cooking fluid from within the container.

In one embodiment of this invention, a quick-release device, such as a clamping device or other similar structural device can be used to quickly release the strainer, the shaft and/or the handle from its rotatably mounted position with respect to the container. Such quick disconnection can provide easy cleaning of the individual components of this invention.

### BRIEF DESCRIPTION OF THE DRAWINGS

The above and other objects of this invention can be better understood when the specification is read in view of the drawings, wherein:

FIG. 1 is a partial cross-sectional view of a strainer rotatably mounted within a container, according to one embodiment of this invention;

FIG. 2 is a partial perspective view of a container having two pressing elements connected to the container;

FIG. 3 is a partial perspective view of an opposite side or portion of the container as shown in FIG. 2, showing a hole within a wall of the container;

FIG. 4 is a partial perspective view of a strainer connected to a shaft which is connected to a handle;

FIG. 5 is a partial perspective view of an opposite side or portion of the strainer, as shown in FIG. 4, showing a second portion of the shaft;

FIG. 6 is a cross-sectional view showing a shaft fitting within an opening of a wall of the container, according to one embodiment of this invention;

FIG. 7 is a cross-sectional view showing a cover for the container and a mounting structure for rotatably attaching the strainer with respect to the container, according to another embodiment of this invention;

FIG. 8 is a partial perspective view of a handle connected to an outer surface of the container, according to one embodiment;

FIG. 9 is a partial perspective view of the handle shown in FIG. 8, and also showing a connector mounted on an inside surface of the container; and

FIG. 10 is a partial cross-sectional view of a container rotatably mounted with respect to a container, according to another embodiment of this invention.

### DESCRIPTION OF PREFERRED EMBODIMENTS

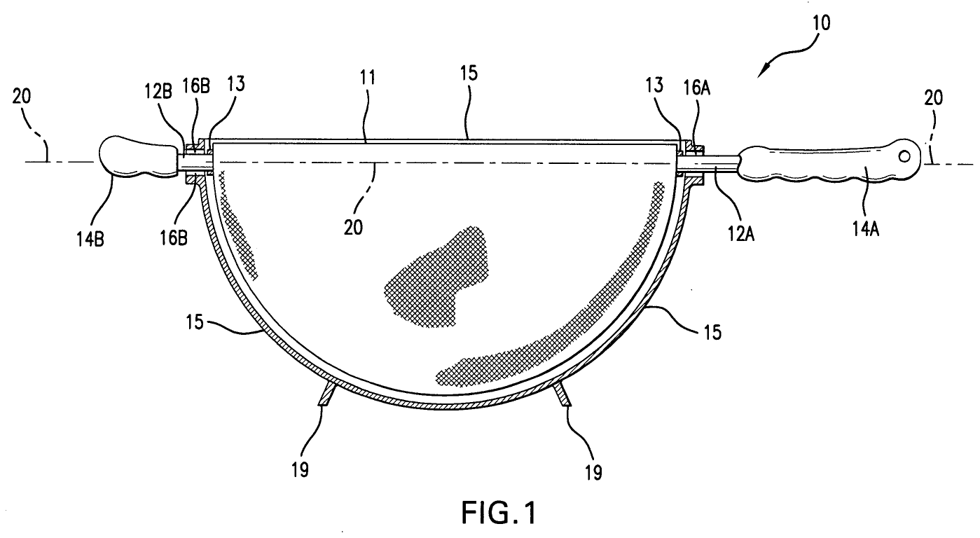

FIG. 1 shows a partial cross-sectional view of kitchen utensil 10, according to one embodiment of this invention. As shown in FIG. 1, kitchen utensil 10 comprises strainer 11 rotatably mounted with respect to bowl or container 15. As used throughout this specification and in the claims, the term strainer is intended to relate to a colander or any other suitable straining device that is used to drain a liquid, such as water, from a solid, such as food. As used throughout this specification and in the claims, the term bowl and the term container are intended to be interchangeable with each other and individually or collectively are intended to relate to a vessel or a pot or any other suitable cooking utensil for housing liquids and/or solids.

As shown in FIG. 1, food cooking apparatus or kitchen utensil 10 of this invention comprises strainer 11 that fits within a housing of container 15, preferably but not necessarily in a corresponding fashion. As shown in FIGS. 1-5, each of strainer 11 and container 15 has a generally semi-spherical shape. It is apparent that strainer 11 and/or container 15 can have a semi-cylindrical shape or any other suitable corresponding shape or any other suitable non-corresponding shape. For example, strainer 11 can have any suitable shape that allows strainer 11 to rotate with respect to bowl 15, preferably about axis 20 which is located along a generally longitudinal direction defined by shaft 12A and/or shaft 12B. As long as strainer 11 clears or does not interfere with container 15 throughout a range of relative rotatable motion of strainer 11 with respect to container 15, strainer 11 can have a shape that does not correspond with the shape of container 15.

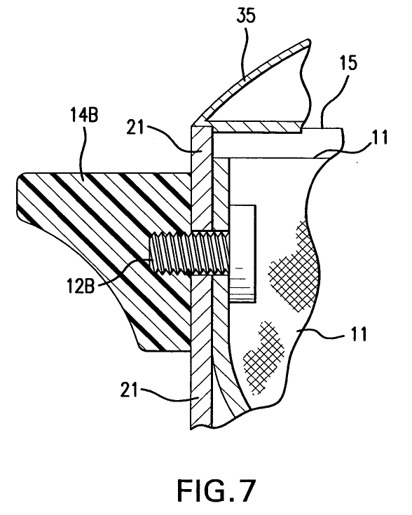

As shown in FIG. 7, cover or lid 35 can be detachably mounted with respect to container 15 and/or strainer 11 to partially or fully close or seal the cooking space formed within container 15 and/or strainer 11. For example, as shown in FIG. 7, a bottom surface of cover or lid 35 can abut or contact an upper surface of container 15 and/or strainer 11. FIG. 7 also shows the upper surface of container 15 higher than an upper surface of strainer 11 and this configuration provides a space between both upper surfaces. However, both upper surfaces can also be at a same elevation.

As shown in FIG. 1, shaft 12A is mounted within bore 16A of container 15 and shaft 12B is mounted within bore 16B of container 15. Shaft 12A and/or shaft 12B each preferably rotates or turns with respect to container 15. Shaft 12A and/or shaft 12B each is indirectly or directly connected to strainer 11. As shown in FIG. 1, shaft 12, strainer 11 and handle 14A rotate about longitudinal axis 20 which passes through shaft 12A and shaft 12B. Any suitable portion of shaft 12A and/or shaft 12B can be rotatably mounted with respect to container 15.

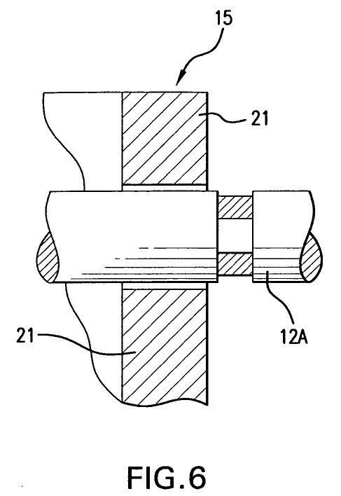

FIG. 6 shows a cross-sectional view of one embodiment for rotatably mounting shaft 12A within opening or bore 16A within wall 21 of container 15. Different types of resistance forces can be used to vary how easily shaft 12A and/or 12B rotate with respect to container 15. For example, a relatively tight clearance between an external surface of shaft 12A and/or shaft 12B and the portion of wall 21 that forms opening 16A and/or opening 16B, respectively, can be used to increase or decrease the frictional resistance between the outside surface of shaft 12A and/or shaft 12B and the corresponding inner surface of wall 21 that forms opening 16A and/or opening 16B. Also, a spring bias force can be applied to urge wall 21 toward and contact shaft 12A and/or shaft 12B, to create increased friction. FIG. 6 shows one embodiment of shaft 12A, having flats about a portion of shaft 12A that can be used to apply a bias force and/or that can be used to rotate shaft 12A.

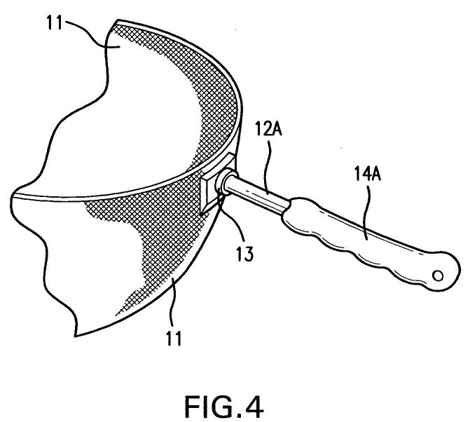

As shown in FIGS. 1 and 4, spacer 13 is connected directly to or with respect to shaft 12A and/or shaft 12B. Spacer 13 can also be integrated with or form one piece with shaft 12A and/or shaft 12B. Spacer 13 can be shaped and sized to limit longitudinal movement or play, such as in a direction generally parallel to axis 20, of shaft 12A and/or shaft 12B, and thus strainer 11, with respect to bowl 15. By increasing a dimension of spacer 13 which spans between strainer 11 and container 15, it is possible to reduce the overall size of strainer 11 without causing movement of strainer 11 with respect to container 15 in a direction generally parallel to longitudinal axis 20. By decreasing the size of strainer 11, it is possible to decrease or eliminate the need to precisely match the overall shape of strainer 11 to the overall shape of container 15. Thus, it is possible to use relatively lesser expensive manufacturing processes for making strainer 11.

As shown in FIGS. 1, 3 and 4, shaft 12A forms a first section and shaft 12B forms a separate second section, for example so that strainer 11 has an unobstructed opening. The first section, shaft 12A, is connected with respect to a first portion of strainer 11. The second section, shaft 12B, is connected with respect to a second portion of the strainer. In one embodiment of this invention, the first portion and the second portion are on opposing sections of the strainer.

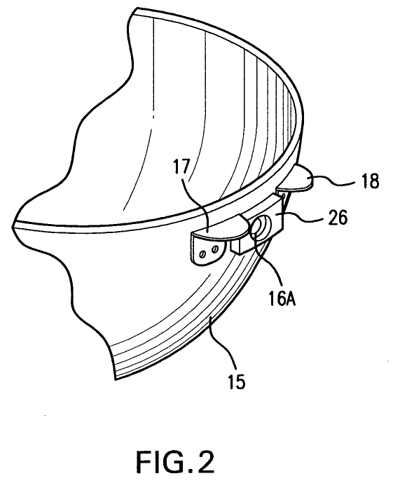

FIG. 2 is a partial perspective view of a portion of container 15. In one embodiment of this invention, the pressing element comprises tab 17 and/or tab 18, each of which is mounted to or otherwise connected with respect to container 15. Tab 17 and/or tab 18 can be integrated with and/or connected to container 15 in any suitable structural attachment manner. One or both of opposing sides of container 15 can have tab 17 and/or tab 18. The pressing element of this invention may comprise any other handle, lever, bar or other suitable structural member that can be used to apply a torque force and thereby cause container 15 to rotate about longitudinal axis 20, with respect to strainer 11. As shown in FIG. 2, having tab 17 on one side of longitudinal axis 20 and tab 18 on an opposite side of longitudinal axis 20 allows a left-handed or a right-handed user to operate kitchen utensil 10 with one hand.

In operation, a user holds handle 14A in one hand and while holding handle 14A uses a thumb or finger of the same hand or another hand to press on either tab 17 or tab 18. The force applied to either tab 17 or tab 18 creates a torque that causes container 15 to rotate or turn with respect to strainer 11, such as about longitudinal axis 20.

As shown in FIG. 1, handle 14B can provide additional support for the user to better grasp, manage and thus support kitchen utensil 10, particularly a relatively large kitchen utensil 10. Thus, for example, if food is contained within strainer 11, strainer 11 can be maintained in a generally horizontal position and container 15 can be rotated downward to the left or downward to the right to dump the liquid, such as hot water, out of container 15.

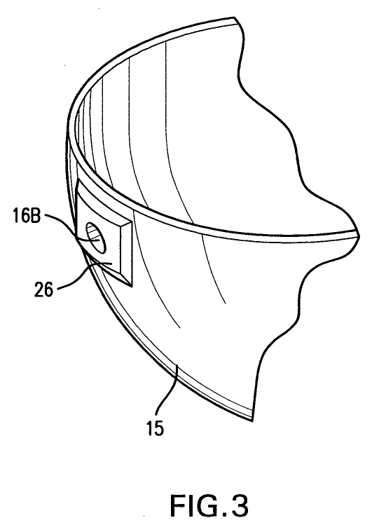

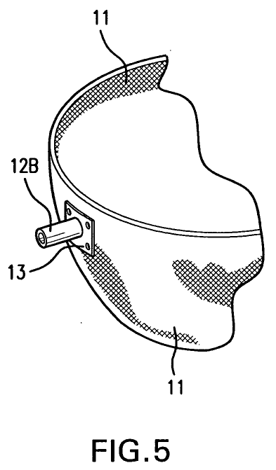

FIG. 3 shows one embodiment of an opposite side of container 15, without tabs 17 and 18. However, tab 17 and/or tab 18 could also be attached to the opposite side of container 15. FIGS. 4 and 5 each shows a perspective view of a portion of strainer 11.

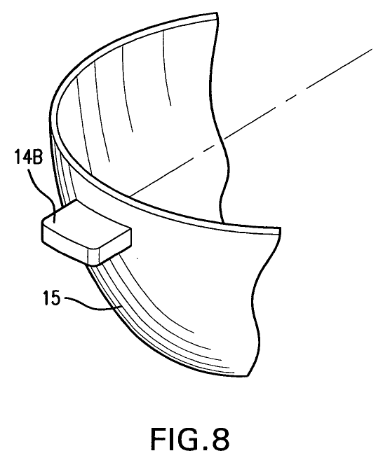

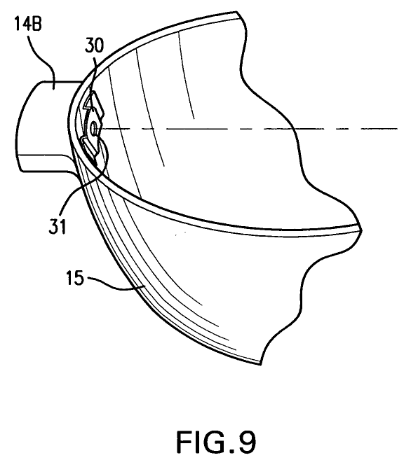

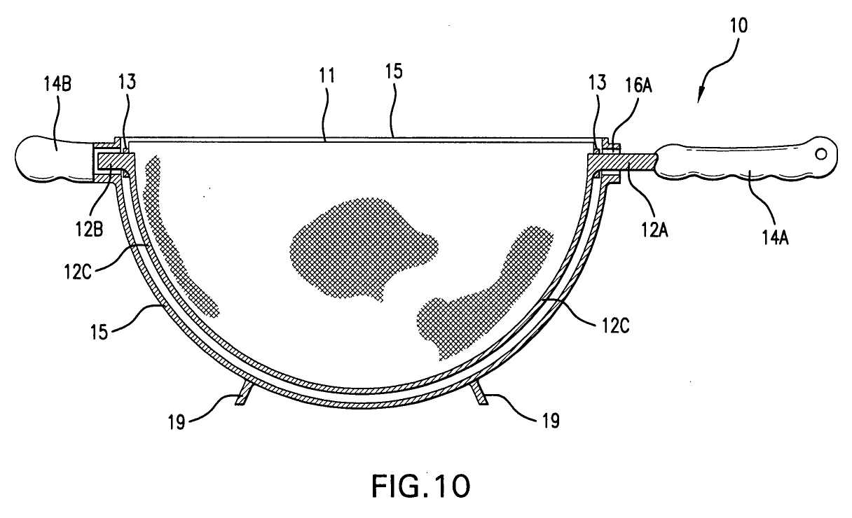

Handle 14A and/or handle 14B can be mounted, attached, connected or otherwise fixed directly to or with respect to container 15 and/or strainer 11, or such as shown in FIG. 10 can even be integrated or formed as one piece with container 15 and/or strainer 11. FIGS. 1 and 4 show handles 14A and 14B connected to shafts 12A and 12B, respectively. In other embodiments of this invention, such as shown in FIGS. 8 and 9, handle 14B can be mounted, attached, connected or otherwise fixed in any suitable manner to contact an outer surface of container 15. FIG. 8 shows an exterior view of handle 14B mounted to and directly contacting container 15. FIG. 9 shows connector 30 mounted, attached, connected or otherwise fixed in any suitable manner to an inner surface of container 15. FIG. 9 also shows connector 30 having opening 31 that can accept insertion of shaft 12B, such as shown in FIG. 5, and allow shaft 12B to rotate within opening 31 and thus allow strainer 11 to rotate with respect to container 15. The dashed line in FIGS. 8 and 9 represents one general direction along which shaft 12B can be inserted or removed from opening 31. As shown in FIG. 10, structural element 12C is connected to or integrated with shaft 12A and shaft 12B to increase the structural integrity of the cooking apparatus by having one continuous shaft element.

In another embodiment of this invention, shaft 12A and/or shaft 12B can have or be mounted using a quick-release device that allows strainer 11 to be easily and quickly detached from its mounted position with respect to container 15. Any suitable latch mechanism or other retaining device can be used to provide a quick-release connection between strainer 11 and container 15. For example, wall 21 of container 15 may form a generally U-shaped opening in which at least a portion of shaft 12A and/or shaft 12B is positioned. A cover or door element can be used to close the upper portion of the general U-shaped opening. Also, a hinged element can be used to pivot the cover or door element into and out of bore 16A and/or bore 16B. Also, a latch mechanism can be used to lock the cover or door element into a latched or closed position.

In a closed position, the quick-release connector can keep or maintain the shaft rotatably mounted with respect to the container. In an open position, the quick-release connector allows the shaft to be removed from the rotatably mounted position, for example to clean or to change the strainer element.

FIGS. 2 and 3 show plate 26, which is used as a reinforcement for the thickness of wall 21. Plate 26 may or may not be used, depending upon the intended use of kitchen utensil 10 and the size, shape and type of materials used for strainer 11 and/or container 15.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

We claim:

1. A food cooking apparatus comprising:
a container having a housing, a strainer fitting within the housing, the container rotatably mounted with respect to the strainer, and a pressing element connected with respect to the container.

2. The food cooking apparatus according to claim 1, wherein the strainer is connected to a shaft.

3. The food cooking apparatus according to claim 2, wherein the strainer rotates about a longitudinal axis of the shaft.

4. The food cooking apparatus according to claim 2, wherein at least a portion of the shaft is rotatably mounted with respect to the container.

5. The food cooking apparatus according to claim 2, wherein the container has an opening and at least a portion of the shaft passes through the opening.

6. The food cooking apparatus according to claim 2, wherein the shaft frictionally contacts a portion of the container forming the opening.

7. The food cooking apparatus according to claim 2 wherein the shaft has a first section and a separate second section, the first section is connected with respect to a first portion of the strainer, and the second section is connected with respect to a second portion of the strainer.

8. The food cooking apparatus according to claim 7, wherein the first portion and the second portion are on opposing sections of the strainer.

9. The food cooking apparatus according to claim 1, further comprising a handle at least one of fixed with respect to the strainer, integrated with the strainer, and integrated with a shaft connected to the strainer.

10. The food cooking apparatus according to claim 9, wherein a wall of the container has an opening and a handle is connected with respect to a shaft that passes at least partially through the opening.

11. The food cooking apparatus according to claim 9, further comprising a second handle fixed with respect to the strainer.

12. The food cooking apparatus according to claim 11, wherein a wall of the container has an opening and the second handle is connected to a shaft that passes at least partially through the opening.

13. The food cooking apparatus according to claim 1, wherein a spacer element is mounted between the strainer and the container.

14. The food cooking apparatus according to claim 13, wherein the spacer element is at least one of integrated with a shaft that is connected to the strainer and connected with respect to the shaft.

15. The food cooking apparatus according to claim 1, wherein the pressing element comprises at least one tab connected with respect to the container.

16. The food cooking apparatus according to claim 1, wherein the strainer is connected to and rotates about a shaft and the pressing element comprises a first tab connected with respect to the container on a first side of a longitudinal axis of the shaft and a second tab connected with respect to the container on a second side of the longitudinal axis.

17. The food cooking apparatus according to claim 1, wherein the pressing element comprises a tab mounted with respect to the container in a position that causes the container to rotate with respect to the strainer as a force is applied to the tab.

18. The food cooking apparatus according to claim 1, wherein a first shape of the strainer corresponds to a second shape of the strainer.

19. The food cooking apparatus according to claim 18, wherein the strainer clears the container during rotatable movement of the strainer with respect to the container.

20. The food cooking apparatus according to claim 18, wherein at least one of the first shape and the second shape is at least one of a generally semi-spherical shape and a generally semi-cylindrical shape.

21. The food cooking apparatus according to claim 1, wherein a first shape of the strainer is different than a second shape of the container.

22. The food cooking apparatus according to claim 1, wherein the container is connected to a shaft, and a quick-release connector rotatably mounts the shaft with respect to the container.

23. The food cooking apparatus according to claim 22, wherein in a closed position the quick release connector keeps the shaft rotatably mounted with respect to the container and in an open position the quick release connector releases the shaft from a rotatably mounted position with respect to the container.

24. The food cooking apparatus according to claim 1, wherein the strainer is connected to a shaft comprising a structural element positioned between and integrated with two opposing shaft portions.
